(19) United States
(12) Patent Application Publication
(10) Pub. No.: US 2026/0194108 A1
(43) Pub. Date: Jul. 9, 2026

(54) WHEEL BEARING FOR VEHICLE

(71) Applicant: HYUNDAI WIA Corporation, Changwon-si (KR)

(72) Inventor: Yun Ho Jung, Uiwang-si (KR)

(73) Assignee: HYUNDAI WIA Corporation, Changwon-si, GG (KR)

(21) Appl. No.: 19/428,051

(22) Filed: Dec. 19, 2025

(30) Foreign Application Priority Data
Dec. 31, 2024 (KR) 10-2024-0202479

(51) Int. Cl. F16C 33/58; B60B 27/00

(52) U.S. Cl. CPC F16C 33/583; B60B 27/0005; B60B 27/0094

(57) ABSTRACT

Disclosed is a wheel bearing for a vehicle. An embodiment of the present disclosure is intended to minimize deformation of an outer race and maintain stable roundness.

### CROSS-REFERENCE TO RELATED APPLICATION

The present application claims priority to Korean Patent Application No. 10-2024-0202479, filed on Dec. 31, 2024 the entire contents of which are incorporated herein for all purposes by this reference.

### BACKGROUND OF THE DISCLOSURE

### Field of the Disclosure

The present disclosure relates to a wheel bearing for a vehicle in which roundness of a large-sized bearing is improved.

### Description of the Related Art

A wheel bearing used in a vehicle serves to mount a vehicle wheel in a vehicle body so that the vehicle wheel of the vehicle may smoothly rotate while causing a minimum frictional loss. Further, a power transmission device of the vehicle, which transmits power generated by an engine of the vehicle to the vehicle wheel, is generally provided with a constant velocity joint.

The constant velocity joint serves to smoothly transmit power of the engine to the vehicle wheel while absorbing displacement in a diameter direction, displacement in an axial direction, or displacement of moment of force from the vehicle wheel when the vehicle bounces or the vehicle turns while the vehicle travels.

Recently, there has been a need to improve fuel economy of the vehicle to save resources and reduce pollution emissions. In order to meet the need, the power transmission device of the vehicle is provided with a power transmission structure in which the constant velocity joint is connected directly to the wheel bearing, which supports the vehicle wheel so that the vehicle wheel is rotatable, in order to achieve weight reduction and improve assemblability and maintainability.

The wheel bearing in the related art will be described with reference to the drawings.

With reference to FIG. 1 attached hereto, the wheel bearing in the related art is configured such that an outer race, which is fastened to and supported by a fixing body, such as a vehicle body or a knuckle, is assembled, at three to four points, to a corresponding member, such as a knuckle or a carrier, by a bolt. During the process of fastening the outer race, an assembling part of the bearing and an assembling part of the knuckle come into contact with each other while being deformed by stress generated by an axial force of the bolt.

The deformation causes contraction and expansion of the outer race of the bearing, which changes roundness of a raceway that is a route along which bearing balls rotate. The change in roundness increases drag torque, which is related to electric power economy of the vehicle, and causes a deterioration in durability and life. Therefore, there is a need for a countermeasure.

### Document of Related Art

(Patent Document 1) Japanese Patent No. 4779313 (Jul. 15, 2011)

### SUMMARY OF THE DISCLOSURE

The present disclosure is proposed to solve these problems and aims to provide a wheel bearing for a vehicle that is capable of minimizing the amount of deformation of a raceway of the wheel bearing.

A wheel bearing for a vehicle according to one embodiment of the present disclosure includes: a hub-and-outer race; an inner race rotatably coupled to an axially outer side of the hub-and-outer race; an outer race coupled to the axially outer side of the hub-and-outer race and provided with a flange portion having a flange hole formed so that a fixing member is inserted into the flange hole; and a ball bearing provided between the inner race and the outer race, in which the outer race is formed to have a first pitch circle diameter (PCD), a thickness T1 of the outer race is maintained to be a first thickness, and a PCD of the flange hole of the outer race is maintained to be a first distance in a radial direction from a center of the flange hole to a knuckle press-fitting diameter.

The first PCD may be maintained to be Φ80 or more.

The first PCD may be selected from any one value between Φ80 and Φ130.

The thickness T1 of the outer race may correspond to a thickness between an inner diameter of a raceway portion formed in an inner circumferential direction and an outer diameter of the outer race.

The thickness T1 of the outer race may be selected from any one value between 7 mm or more and 9 mm or less.

The first distance may be selected from any one value between 9 mm or more and 12 mm or less.

A thickness T2 of the flange portion of the outer race may be selected from any one value between 12 mm or more and 14 mm or less.

The flange portion may extend and be inclined at an inclination angle θ in an inboard direction of the outer race when viewed from the outside, and the inclination angle θ may be selected from any one value between 0 degrees and 0.2 degrees.

### BRIEF DESCRIPTION OF THE DRAWINGS

FIG. 1 is a view briefly illustrating a state in which an outer race of a wheel bearing in the related art is deformed by an axial force of a bolt.

FIG. 2 is an exploded perspective view illustrating a configuration of a wheel bearing for a vehicle according to the present embodiment.

FIGS. 3 to 6 are cross-sectional views illustrating detailed dimensions of the wheel bearing for a vehicle according to the present embodiment.

FIG. 7 is a graph illustrating a result of comparing roundness and weight with respect to thicknesses T1 of an outer race of the wheel bearing for a vehicle according to the present embodiment.

FIG. 8 is a graph illustrating a result of comparing roundness with respect to thicknesses T2 of a flange portion of the outer race according to the present embodiment.

FIG. 9 is a graph illustrating a result of comparing roundness with respect to first distances according to the present embodiment.

FIG. 10 is a graph illustrating a result of comparing roundness with respect to inclination angles according to the present embodiment.

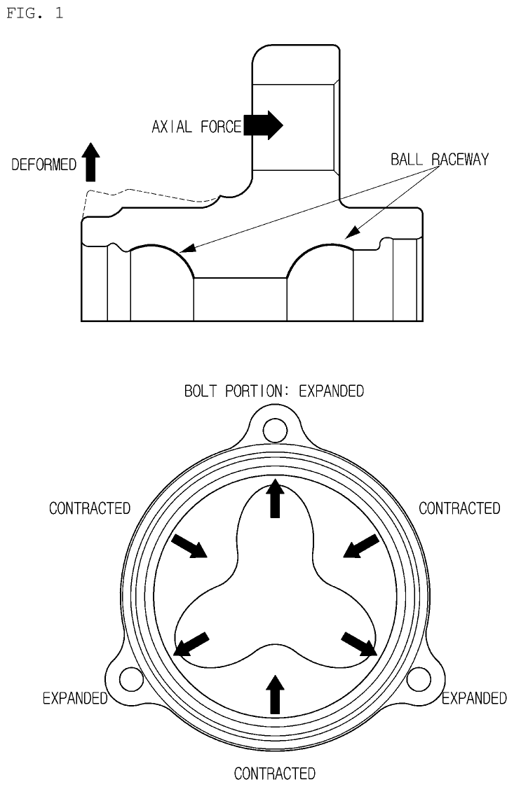

### DETAILED DESCRIPTION OF THE DISCLOSURE

Advantages and features of the present disclosure and methods of achieving the advantages and features will be clear with reference to exemplary embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art to which the present disclosure pertains can fully understand the scope of the present disclosure. The present disclosure will be defined only by the scope of the appended claims. Throughout the specification, the same reference numerals denote the same constituent elements.

A configuration in which one constituent element is “connected to” or “coupled to” another constituent element includes both a configuration in which one constituent element is connected or coupled directly to another constituent element and a configuration in which another constituent element is interposed therebetween. In contrast, when one constituent element is “connected directly to” or “coupled directly to” another constituent element, there are no constituent elements interposed therebetween. The term “and/or” includes each and all combinations of one or more of the mentioned items.

The terms used in the present specification are for explaining the embodiments, not for limiting the present disclosure. Unless particularly stated otherwise in the present specification, a singular form also includes a plural form. The terms “comprise (include) ” and/or “comprising (including) ” used in the specification are intended to specify the presence of the mentioned constituent elements, steps, operations, and/or elements, but do not exclude the presence or addition of one or more other constituent elements, steps, operations, and/or elements.

The terms “first”, “second”, and the like may be used to describe various components, but the components are of course not limited by these terms. These terms are merely used to distinguish one component from another component.

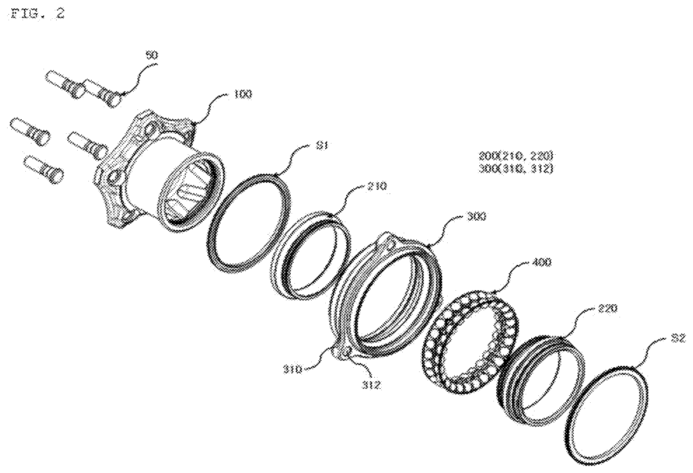

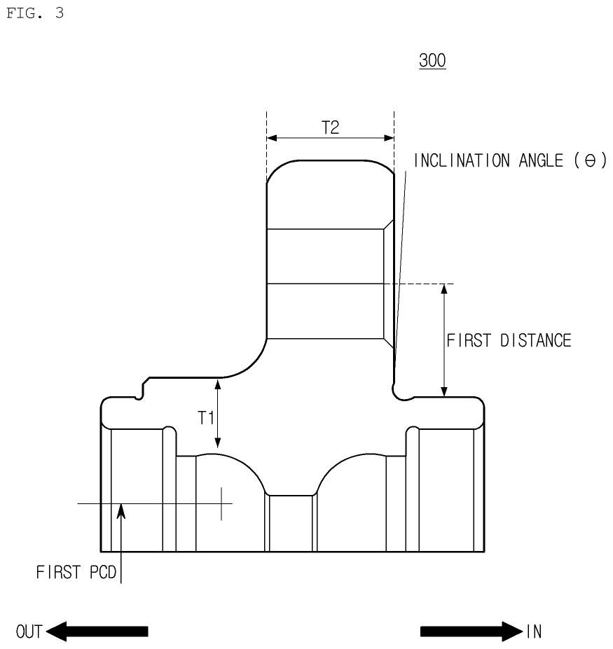

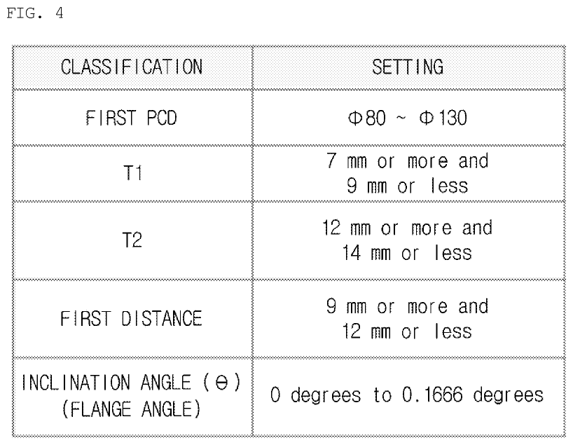

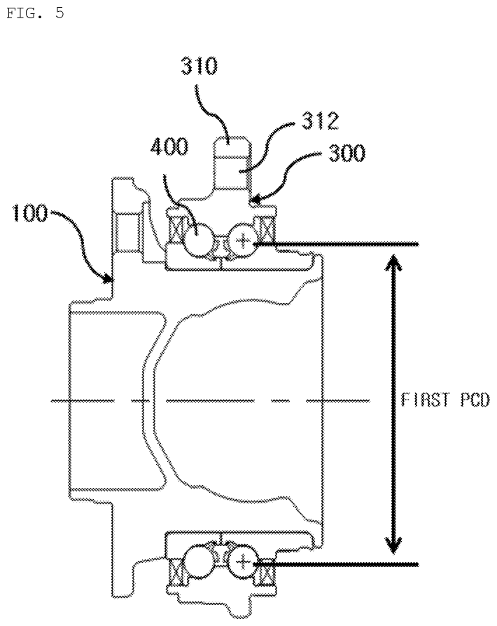

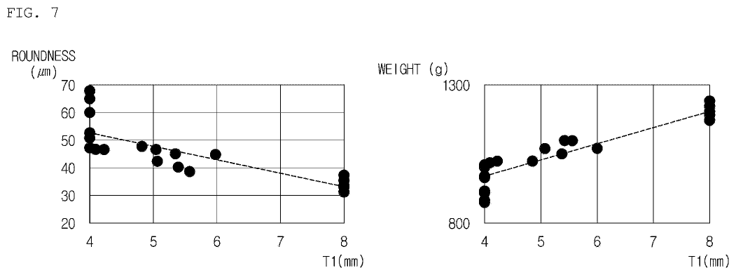

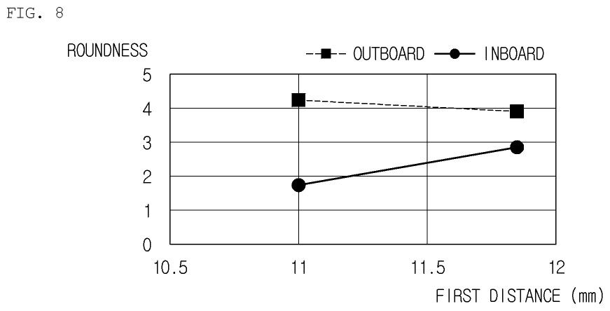

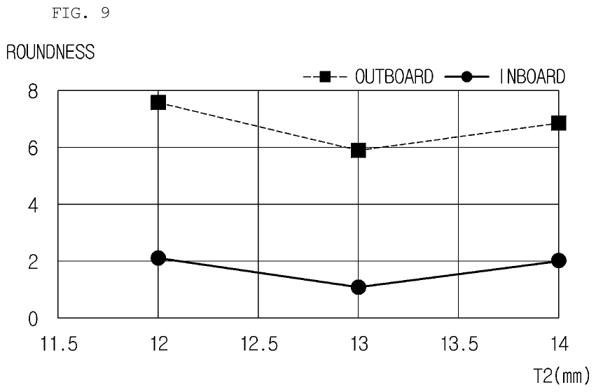

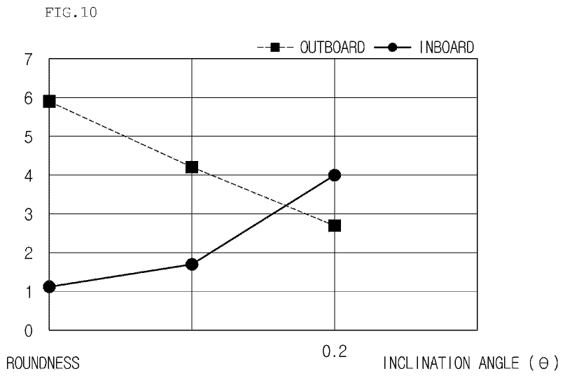

A wheel bearing for a vehicle according to an embodiment of the present disclosure will be described with reference to the drawings. FIG. 2 attached hereto is an exploded perspective view illustrating a configuration of a wheel bearing for a vehicle according to the present embodiment, FIGS. 3 to 6 are cross-sectional views illustrating detailed dimensions of the wheel bearing for a vehicle according to the present embodiment, FIG. 7 is a graph illustrating a result of comparing roundness and weight with respect to thicknesses T1 of an outer race of the wheel bearing for a vehicle according to the present embodiment, FIG. 8 is a graph illustrating a result of comparing roundness with respect to thicknesses T2 of a flange portion of the outer race according to the present embodiment, FIG. 9 is a graph illustrating a result of comparing roundness with respect to first distances according to the present embodiment, and FIG. 10 is a graph illustrating a result of comparing roundness with respect to inclination angles according to the present embodiment.

With reference to FIGS. 2 to 10 attached hereto, the wheel bearing for a vehicle according to the present embodiment includes a hub-and-outer race 100, an inner race 200 rotatably coupled to an axially outer side of the hub-and-outer race 100, an outer race 300 coupled to the axially outer side of the hub-and-outer race 100 and provided with a flange portion 310 having flange holes 312 formed such that fixing members 50 are inserted into the flange holes 312, and a ball bearing 400 provided between the inner race 200 and the outer race 300. The outer race 300 is formed to have a first pitch circle diameter (PCD), the thickness T1 of the outer race 300 is maintained to be a first thickness, a PCD of the flange hole 312 of the outer race 300 is maintained to be the first distance in a radial direction from a center of the flange hole 312 to a knuckle press-fitting diameter. For reference, for understanding the description, an inboard direction (drive shaft direction) is indicated by IN, and an outboard direction (wheel direction) is indicated by OUT.

With reference to FIGS. 3 to 5 attached hereto, in case that the outer race 300 according to the present embodiment has the specifications in which a PCD of the ball bearing 400 is large, a degree to which a change in roundness of the raceway affects an increase in drag torque during the fastening process using the fixing member 50 is high. Therefore, in case that the large-sized ball bearing 400 is used, detailed dimensions of the outer race 300 needs to be specially defined as in the present application to maintain stable roundness.

In addition, it is possible to minimize deformation of the outer race 300 caused by a fastening force when the fastening process is performed by using the fixing member 50.

To this end, in the present embodiment, a first PCD of the outer race 300 is limited to Φ90 or more, such that the above-mentioned operational effect may be achieved. For example, because the first PCD affects the roundness as a magnitude of the first PCD increases, the first PCD is defined by the above-mentioned numerical value.

For example, the first PCD may be selected from any one value between Φ80 and Φ130 together with the above-mentioned numerical value. Because the roundness becomes disadvantageous in case that the first PCD exceeds Φ130, it is advantageous to maintain the first PCD within the above-mentioned numerical value range to ensure roundness safety and coupling properties.

With reference to FIG. 3 7 attached hereto, the thickness T1 of the outer race 300 according to the present embodiment may correspond to a thickness between an inner diameter of a raceway portion formed in an inner circumferential direction and an outer diameter of the outer race 300, and the thickness T1 of the outer race 300 may be selected from any one value between 7 mm or more and 9 mm or less.

The thickness T1 of the outer race 300 maintains a correlation with roundness, and the roundness is improved as the thickness T1 of the outer race 300 increases. However, the weight of the outer race 300 increases, which increases the weight of the vehicle.

Therefore, in the present embodiment, the thickness is selected between 7 mm or more and 9 mm or less that corresponds to a range in which the roundness is improved without increasing the weight of the outer race 300, thereby stabilizing the roundness and preventing an excessive increase in weight.

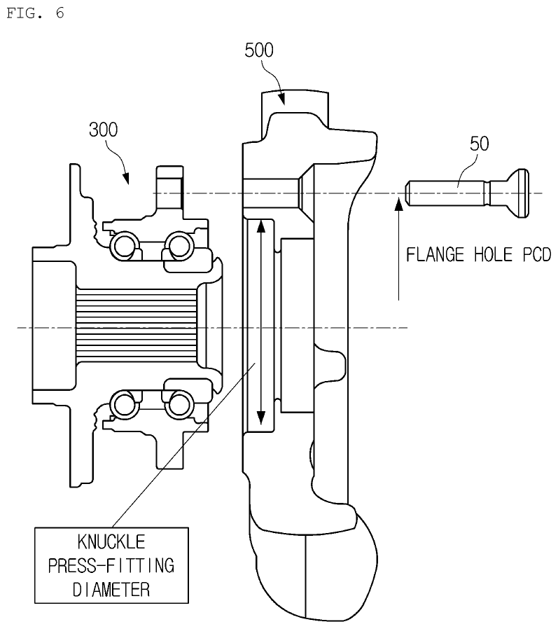

With reference to FIG. 6 or 8 attached hereto, the PCD of the flange hole 312 of the outer race 300 according to the present embodiment is defined as a first distance from the center of the flange hole 312 to the knuckle press-fitting diameter.

As illustrated in the drawings, the first distance maintains the correlation with the amount of change in roundness. For example, as the first distance increases, the outboard roundness is improved, but the inboard roundness may increase inversely, which causes a disadvantage.

The first distance may be selected from any one value between 9 mm or more and 12 mm or less. In the present embodiment, the first distance may be selected as any numerical value within a numerical value range, which does not exceed at most 12 mm or more in consideration of the outboard roundness and the inboard roundness according to the first distance.

In this case, in the present embodiment, it is possible to maintain stable roundness without increasing the weight of the outer race 300.

With reference to FIG. 9 attached hereto, the thickness T2 of the flange portion 310 of the outer race 300 according to the present embodiment may be selected from any one value between 12 mm or more and 14 mm or less.

The thickness T2 of the flange portion 310 is related directly to the roundness of the outer race 300 and needs to be ensured to be at least 10 mm or more in order to couple the fixing member 50.

The weight of the outer race 300 increases as the thickness T2 of the flange portion 310 increases, which may make the roundness disadvantageous. In consideration of this configuration, the thickness T2 of the flange portion 310 is selected within a range that does not exceed at most N mm.

For example, in the present embodiment, an optimal state may be maintained when the thickness T2 of the flange portion 310 is selected from any one numerical value of 12 mm or more or 12 mm to 14 mm in consideration of the weight of the outer race 300.

Therefore, in the present embodiment, the thickness T2 of the flange portion 310 of the outer race 300 is selected within the above-mentioned numerical value range in consideration of the weight and the roundness, such that the roundness may be maintained within a stable range, and unnecessary drag torque may also be reduced.

With reference to FIG. 3 or 10 attached hereto, the flange portion 310 according to the present embodiment may be formed such that the flange portion 310 extends and is inclined at an inclination angle θ in the inboard direction of the outer race 300 when viewed from the outside, and the inclination angle θ may be selected from any one value between 0 degrees and 0.2 degrees. For reference, the inboard direction is indicated by the English character “IN”, and the outboard direction is indicated by the English character “OUT”.

As the inclination angle θ increases, the outboard roundness is improved, but the inboard roundness increases. Therefore, the inclination angle θ is selected within a range that does not exceed 0.1666 degrees.

According to the embodiments of the present disclosure, it is possible to prevent deformation of the large-sized bearing.

According to the present embodiments, it is possible to minimize the amount of deformation of the raceway of the wheel bearing and maintain stable roundness.

According to the present embodiments, it is possible to prevent an increase in weight of the outer race and allow the wheel bearing with an optimal weight to be stably installed.

While the exemplary embodiments of the present disclosure have been described above, those skilled in the art may variously modify and change the present disclosure by adding, changing, deleting or modifying constituent elements without departing from the spirit of the present disclosure disclosed in the claims, and the modification and change also belong to the scope of the present disclosure.

### DESCRIPTION OF REFERENCE NUMERALS

100: Hub-and-outer race
200: Inner race
300: Outer race
310: Flange portion
312: Flange hole
400: Ball bearing
T1: Outer race thickness
T2: Flange portion thickness

What is claimed is:

1. A wheel bearing for a vehicle, the wheel bearing comprising:
a hub-and-outer race;
an inner race rotatably coupled to an axially outer side of the hub-and-outer race;
an outer race coupled to the axially outer side of the hub-and-outer race and provided with a flange portion having a flange hole formed so that a fixing member is inserted into the flange hole; and
a ball bearing provided between the inner race and the outer race,
wherein the outer race is formed to have a first pitch circle diameter (PCD), a thickness T1 of the outer race is maintained to be a first thickness, and a PCD of the flange hole of the outer race is maintained to be a first distance in a radial direction from a center of the flange hole to a knuckle press-fitting diameter.

2. The wheel bearing of claim 1, wherein the first PCD is maintained to be Φ80 or more.

3. The wheel bearing of claim 1, wherein the first PCD is selected from any one value between Φ80 and Φ130.

4. The wheel bearing of claim 1, wherein the thickness T1 of the outer race corresponds to a thickness between an inner diameter of a raceway portion formed in an inner circumferential direction and an outer diameter of the outer race.

5. The wheel bearing of claim 4, wherein the thickness T1 of the outer race is selected from any one value between 7 mm or more and 9 mm or less.

6. The wheel bearing of claim 1, wherein the first distance is selected from any one value between 9 mm or more and 12 mm or less.

7. The wheel bearing of claim 1, wherein a thickness T2 of the flange portion of the outer race is selected from any one value between 12 mm or more and 14 mm or less.

8. The wheel bearing of claim 1, wherein the flange portion extends and is inclined at an inclination angle θ in an inboard direction of the outer race when viewed from the outside, and the inclination angle θ is selected from any one value between 0 degrees and 0.2 degrees.
